(19) United States
(12) Patent Application Publication
(10) Pub. No.: US 2025/0332969 A1
(43) Pub. Date: Oct. 30, 2025

(54) Heated Tailgate Seat

(71) Applicant: John David Swan, London (CA)

(72) Inventor: John David Swan, London (CA)

(21) Appl. No.: 18/648,578

(22) Filed: Apr. 29, 2024

(51) Int. Cl. B60N 2/30; B60N 2/56; B60N 3/10

(52) U.S. Cl. CPC B60N 2/3097; B60N 2/3095; B60N 2/5685; B60N 3/103

(57) ABSTRACT

A heated tailgate seat is provided. The heated tailgate seat comprises a base with an integrated heating element, designed to fit a tailgate of a vehicle. The device features two side-by-side seating areas with a contoured surface for user comfort, and a central console positioned between the seating areas. The console houses a control for the heating elements and, in some embodiments, an accessory or cup holder. The heating element is operably connected to the vehicle's power source via a trailer plug, providing quick warmth to the seat's surface. The base of the seat includes apertures for securing the device onto the tailgate with bungee cords or similar fastener. A top waterproof layer covers an insulated thermal layer and heating element, optimizing heat retention. The heated tailgate seat transforms the utility of vehicle tailgates into a comfortable, heated seating arrangement, for tailgate parties, concerts, picnics, and other events.

### BACKGROUND OF THE INVENTION

The present invention relates to seats. The present invention provides a heated seat adapted to secure to a tailgate of a vehicle and connect to the vehicle as a power source.

The present invention relates to the domain of portable seating solutions, with a particular focus on an innovative heated tailgate seat designed to significantly enhance the user experience at outdoor events. Outdoor gatherings, including tailgate parties, outdoor concerts, and picnics, are popular activities that bring people together in open-air settings. The comfort and convenience of the seating options available at such events are crucial to the overall enjoyment and experience of attendees. Traditional seating solutions like portable folding chairs, blankets, and makeshift seats have long been staples at these events, each with its set of challenges and discomforts.

Portable folding chairs, the most common seating option, provide a basic level of comfort but fail to address the cold experienced during cooler weather conditions. These chairs are also cumbersome to transport, particularly when space is at a premium, such as in the cargo areas of pickup trucks and SUVs. While some folding chairs offer minimal insulation or fabric padding, these features are insufficient for warmth and do not provide the ergonomic support needed for extended periods of sitting.

Blankets, another widely used option, offer flexibility in seating location but lack structural support, leading to discomfort over time. Additionally, blankets placed directly on the ground do not protect users from cold and moisture, which can further detract from the outdoor experience.

Existing heated seating solutions designed for outdoor use often rely on bulky, inefficient heating mechanisms that are not suited for transport or quick setup. These solutions typically require external power sources that are impractical or unavailable in many outdoor settings, limiting their usability. Moreover, the durability of such seats under outdoor conditions is frequently compromised, reflecting a significant gap in the market for a robust, user-friendly, and warm seating option.

In response to these identified shortcomings, the heated tailgate seat provides enhanced comfort and convenience of outdoor event attendees. This invention leverages a combination of portable design, efficient heating technology, and user-centric features to address the limitations of existing outdoor seating solutions. The seat's design includes a base that houses an integrated heating element, providing immediate warmth to users. The heated tailgate seat is engineered to fit securely on the tailgate of a pickup truck or the back of an SUV, utilizing the vehicle's power source for energy, thereby solving the problem of external power supply. The seat features a contoured design for ergonomic support and includes a central console with accessory holders. These features merge functionality with comfort.

In light of the devices disclosed in the known art, it is submitted that the present invention substantially diverges in design elements and methods from the known art and consequently it is clear that there is a need in the art for an improvement for a heated tailgate seat. In this regard the instant invention substantially fulfills these needs.

### SUMMARY OF THE INVENTION

In view of the foregoing disadvantages inherent in the known types of heated tailgate seats now present in the known art, the present invention provides a new heated tailgate seat wherein the same can be utilized for securing to a tailgate of a vehicle and providing a heated portable seat.

It is an objective of the present invention to provide a heated tailgate seat comprising a base having a lower side and an upper side, wherein a heating element is disposed therebetween. A seating area is disposed on the upper side of the base and a console extends from the base. The console includes controls operably connected to the heating element. The present invention further includes an electrical connection interface for connecting the heating element to a vehicle's external power source via a trailer plug. The heated tailgate seat further comprises a fastener configured to secure the base to a tailgate of a vehicle.

It is an objective of the present invention to provide a heated tailgate seat that is easily portable and quick to set up. The seat is designed to fit on the tailgate of a pickup truck or the floor of an SUV and is secured in place with bungee cords or similar fastening devices. This design allows for effortless transportation and setup, making it ideal for various outdoor activities.

It is an objective of the present invention to provide a heated tailgate seat comprising a seating area having a contoured surface designed to align with the user's bottom for enhanced comfort, and a middle console equipped with controls for the heating element and holders for accessories, thereby merging functionality with user comfort.

It is an objective of the present invention to offer a heated tailgate seat that is durable and suitable for outdoor use. The seat is constructed from materials selected for their durability and resistance to outdoor conditions, ensuring the longevity of the seat and reliability of the heating functionality over time.

It is an objective of the present invention to provide a heated tailgate seat configured to utilize existing vehicle infrastructure for power, eliminating the need for external power sources. By connecting to the vehicle's trailer plug for electricity, the seat avoids the limitations of battery power or the need for external electrical sources, streamlining the user experience and enhancing the seat's utility.

It is therefore an object of the present invention to provide a new and improved heated tailgate seat that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a top plan view of an embodiment of the heated tailgate seat.

FIG. 2 shows a front view of an embodiment of the heated tailgate seat.

FIG. 3 shows a cross sectional view of the base of an embodiment of the heated tailgate seat.

FIG. 4 shows a block diagram of an embodiment of the heated tailgate seat.

FIG. 5 shows a perspective view of an embodiment of the heated tailgate seat in use.

### DETAILED DESCRIPTION OF THE INVENTION

Reference is made herein to the attached drawings. For the purpose of presenting a brief and clear description of the present invention, the preferred embodiment will be discussed as used for securing the heated tailgate seat to a tailgate of a vehicle. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

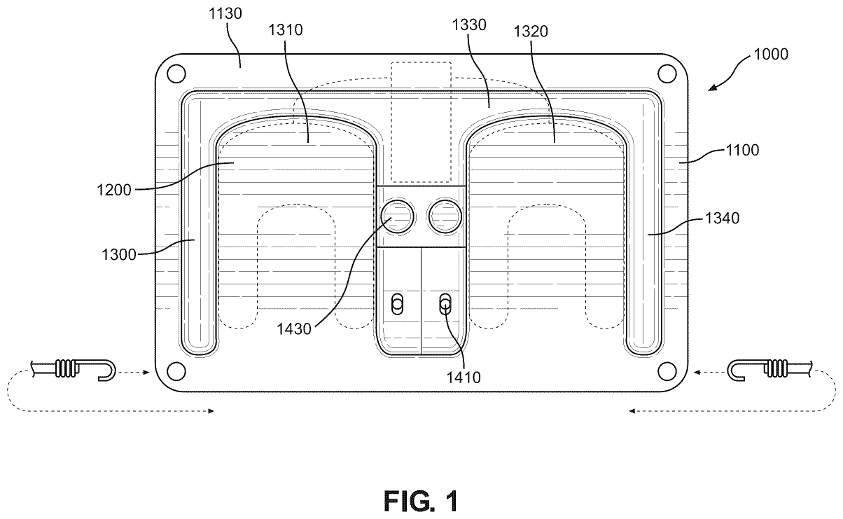

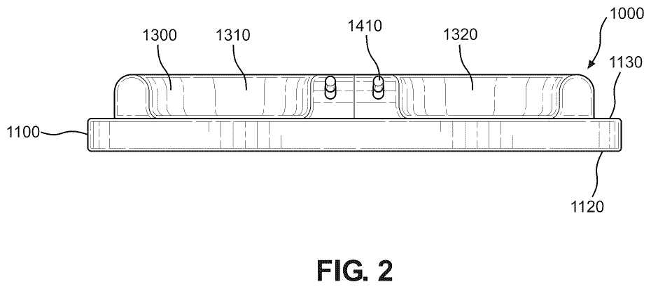

Referring now to FIGS. 1 and 2, there is shown a top planar view and a front view of an embodiment of the heated tailgate seat, respectively. The heated tailgate seat 1000 comprises a base 1100 with an integrated heating element 1200, designed to fit a tailgate of a pickup truck or an interior space of a vehicle, such as a sport utility vehicle (SUV). The base 1100 of the heated tailgate seat 1000 comprises a lower side 1120 and an upper side 1130, wherein the heating element 1200 is disposed therebetween. In the illustrated embodiment, the base 1100 comprises a rectangular shaped cross section designed to fit within the boundary of a tailgate. In alternate embodiments, the base 1100 comprises any suitable shape, such as a square, oval, irregular shape, or the like. The base 1100 comprises a 50 to 60 inch length and a 15 to 25 inch width, wherein the length is measured between opposing lateral sides and the width is measured between a front and rear side of the base 1100. In some embodiments, the lower side of the base 1100 is flat. In alternate embodiments, the lower side of the base 1100 comprises a pattern of recesses or ridges configured to align with a pattern on the surface of the tailgate.

In the shown embodiment, the base 1100 is secured to the tailgate via a fastener and comprises a plurality of apertures 1150 configured to receive a fastener configured to secure the base to a tailgate of a vehicle. The fastener comprises apertures 1270 located on corners of the base for securing the heated tailgate seat to a tailgate using bungee cords 1280 or similar fastening devices. In alternate embodiments, the weight of the base secures the heated tailgate seat to the tailgate. In other embodiments, the lower side of the base comprises a non-slip material configured to help maintain the position of the heated tailgate seat when disposed on the tailgate and during use.

In the shown embodiment, a seating area 1300 is disposed on the upper side 1130 of the base 1100. In the illustrated embodiment, the seating area 1300 comprises a pair of seats 1310, 1320 disposed side by side. Each of the seats of the pair of seats 1310, 1320 comprise a contoured surface designed to align with a user's bottom. The seating area 1300 is formed by a sidewall 1330 extending along the rear side and lateral sides of the base 1100. In this way, the sidewall 1330 disposed along the rear side serves as a backrest to the user when seated thereupon and the sidewall 1330 disposed along the lateral sides serves as an armrest. In alternate embodiments, the sidewall only extends along the rear side of the base, whereas in other embodiments, the seating area is void of a sidewall. The pair of seats each comprise a width of approximately 20 to 25 inches.

In the illustrated embodiment, a console 1400 extends from a middle section of the base 1100, between the pair of seats 1310, 1320. The console 1400 extends from the sidewall 1330 on the rear side of the base 1100 and slopes downward towards a front side of the base 1100. The console 1400 includes controls operably connected to the heating element 1200 that allows a user to activate and control the temperature of the heating element. In the illustrated embodiment, the control comprises a pair of knobs 1410 each disposed on opposite sides of the console 1400 enabling a user sitting in the first seat 1310 to activate and control the temperature thereof and a second user sitting in the second seat 1320 to independently activate and control the temperature thereof.

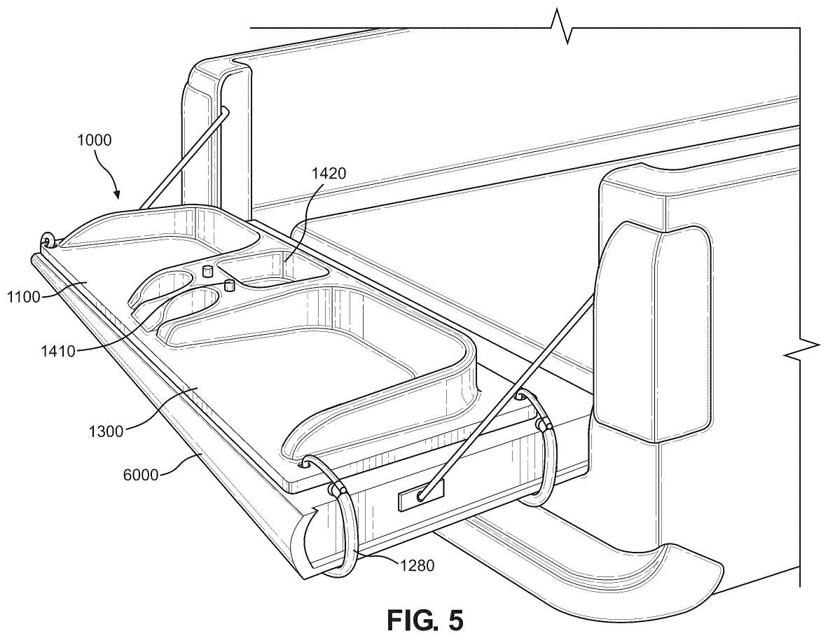

The console 1400 further comprises an accessory holder. In some embodiments, the accessory holder is a storage compartment (seen in FIG. 4, 1420) for small personal items configured to hold accessories such as a wallet, sunglasses, food item, etc. In the illustrated embodiment, the console 1400 further comprises a beverage holder 1430 adapted to hold a variety of sizes of cups or devices. Both the accessory holder and beverage holder form recesses or cutouts within an upper side of the console 1400.

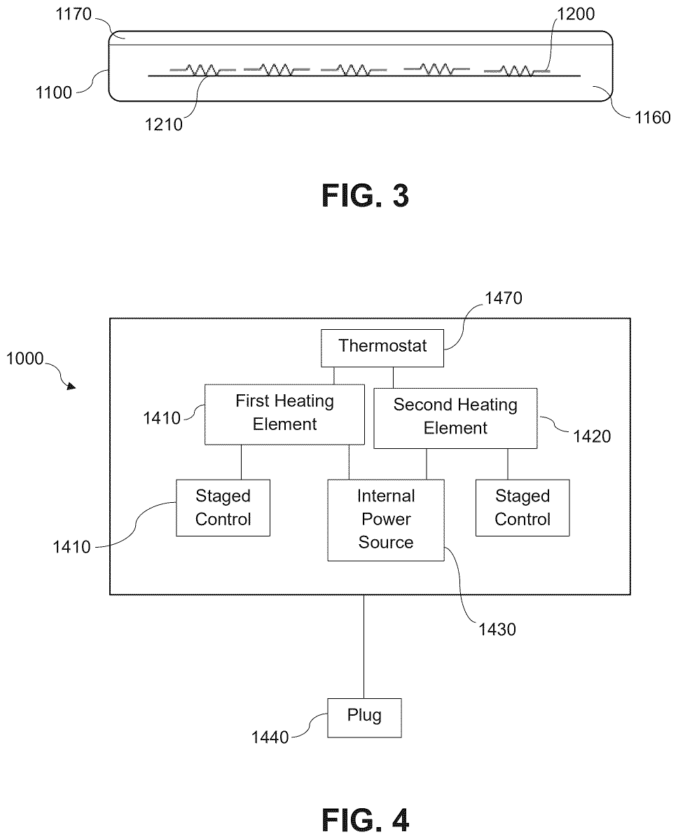

Referring now to FIG. 3, there is shown a cross sectional view of the base of an embodiment of the heated tailgate seat. In the illustrated embodiment, the base 1100 comprises an interior section 1160 having an insulation thermal insulation layer 1210 with the heating element 1200 disposed thereon, wherein the thermal insulation layer 1210 is configured to direct heat upwards towards the seating surface. The heating element 1200 is distributed across the base 1100 to provide uniform warmth to the seating area. In the illustrated embodiment, a top layer 1170 covers the interior section 1160, the thermal insulation layer and the heating element, wherein the top layer is a waterproof material such as marine vinyl or similar material. The outer layer is configured to protect the electrical components from moisture. In some embodiments, the interior section is foam. The base 1100 can be constructed using blown, plastic injection molding or fiberglass, wherein the heating element is added after construction of the base.

Referring now to FIG. 4, there is shown a block diagram of an embodiment of the heated tailgate seat. In the illustrated embodiment, the heated tailgate seat 1000 comprises a first and second heating element 1410, 1420 operably connected to an exterior plug 1440 for securing to a vehicle's power source via a trailer connection. In some embodiments, the heating elements 1410, 1420 are operably connected to an internal power source 1430, such as a battery. In the shown embodiment, the heated tailgate seat 1000 comprises both an internal power source 1430 and an option to connect to an external power source via the plug 1440. The plug 1440 is configured to connect to any suitable input available within a vehicle, such as a USB port, three prong port, etc.

The heating elements 1410, 1420 are operably connected to a control 1410 configured to allow for staged heating, wherein the controls also allow for automatic shut off when a predetermined temperature is reached as detected by an internal thermostat 1470. In the illustrated embodiment, the heating elements are configured to reach a temperature between 150 to 185 degrees Fahrenheit before automatically shutting off.

Referring now to FIG. 5, there is shown a perspective view of an embodiment of the heated tailgate seat in use. In operation, the tailgate 6000 of a vehicle is lowered and the heated tailgate seat 1000 is placed thereon. The tailgate seat 1000 is secured in place using bungee cords 1280 attached through the apertures on the base 1100, providing a stable and comfortable heated seating arrangement for outdoor events. The electrical connection interface is then connected to the vehicle's trailer plug or other power source. Once secured and connected, one or more users are able to sit within the seating area 1300 and activate the heating element via the controls 1410. The user can adjust the temperature via the controls located on the console, ensuring the seating surface is warmed to the desired level.

Other embodiments of the heated tailgate seat may include variations in the size, shape, and arrangement of the seating areas and console, as well as the type and distribution of the heating elements, to accommodate different vehicle sizes and user preferences. For example, an alternative embodiment may feature a single, wider seating area designed for individual use, with a correspondingly adapted console for enhanced personal comfort.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A heated tailgate seat, comprising:
a base having a lower side and an upper side, wherein a heating element is disposed therebetween;
a seating area disposed on the upper side of the base;
a console extending from the base, the console including controls operably connected to the heating element;
an electrical connection interface for connecting the heating element to a vehicle's power source via a plug;
a fastener configured to secure the base to a tailgate of a vehicle.

2. The heated tailgate seat of claim 1, wherein the seating area comprises a contoured surface designed to align with a user's bottom.

3. The heated tailgate seat of claim 1, wherein the seating area comprises a pair of seats disposed side by side.

4. The heated tailgate seat of claim 3, wherein the console is disposed between the pair of seats.

5. The heated tailgate seat of claim 1, wherein the console comprises at least one accessory holder.

6. The heated tailgate seat of claim 5, wherein the accessory holder in the console is adaptable to hold a variety of sizes of cups or devices.

7. The heated tailgate seat of claim 1, wherein the console further comprises a storage compartment for small personal items.

8. The heated tailgate seat of claim 1, wherein the fastener comprises apertures located on corners of the base for securing the heated tailgate seat to a tailgate using bungee cords or similar fastening devices.

9. The heated tailgate seat of claim 1, wherein the base comprises an interior section that contains an insulated thermal layer disposed beneath the heating element.

10. The heated tailgate seat of claim 9, wherein the insulated thermal layer is configured to direct heat from the heating element towards the seating area.

11. The heated tailgate seat of claim 10, wherein the heating element is evenly distributed across the base to provide uniform warmth across the seating area.

12. The heated tailgate seat of claim 1, further comprising a thermal insulation layer positioned between the base and the heating element to direct heat upwards towards the seating surface.

13. The heated tailgate seat of claim 1, wherein the electrical connection interface includes a voltage regulator to adapt the received power supply to a suitable voltage for the heating element.

14. The heated tailgate seat of claim 1, further comprising a waterproof exterior layer atop the insulated thermal layer to protect the heating element from moisture.

15. The heated tailgate seat of claim 1, wherein the base includes non-slip surface on its underside to prevent movement of the seat when placed on a surface.

16. The heated tailgate seat of claim 1, wherein the seating area comprises a sidewall extending along a rear side of the base and configured to serve as a backrest.

17. The heated tailgate seat of claim 16, wherein the sidewall extends along a pair of opposing lateral sides of the base and configured to serve as an armrest.

18. The heated tailgate seat of claim 1, further comprising a thermostat disposed within the base and operably connected to the heating element, wherein the heating element is configured to automatically shut off when the thermostat reaches a predetermined temperature.

19. The heated tailgate seat of claim 1, wherein the seating area is disposed within the boundary of an exterior perimeter of the base.

20. The heated tailgate seat of claim 1, wherein the console extends a majority of a width of the base.
